(19) United States
(12) Patent Application Publication
(10) Pub. No.: US 2021/0390306 A1
(43) Pub. Date: Dec. 16, 2021

(54) AR SYSTEM FOR ENHANCED BOOK COVERS AND RELATED METHODS

(71) Applicant: FINDERSCOPE, INC., WINTER PARK, FL (US)

(72) Inventors: STEVEN R. NICHOLS, WINDERMERE, FL (US); DAVID MORALES, WINTER PARK, FL (US); TIMOTHY SANTOR, WINTER PARK, FL (US)

(21) Appl. No.: 17/286,533

(22) PCT Filed: Oct. 15, 2019
(86) PCT No.: PCT/US2019/056197

§ 371 Date: Apr. 19, 2021

Related U.S. Application Data
(60) Provisional application No. 62/749,284, filed on Oct. 23, 2018.

(51) Int. Cl. G06K 9/00; G06K 9/62; G06T 11/00; G06Q 30/06; G06Q 30/02

(52) U.S. Cl. CPC G06K 9/00671; G06K 9/6202; G06Q 30/0283; G06Q 30/0625; G06T 11/00

(57) ABSTRACT

An AR system may include a mobile wireless communications device configured to operate an image sensor to generate image data of a book cover from a given book. The AR system may include a server configured to store a database for different books and having book cover images respectively for the different books, and AR data sets respectively for the different books. The server may be configured to receive the image data of the book cover of the given book, and compare the image data with each of the book cover images to determine a matching book cover image and a matching AR data set from the database. The mobile wireless communications device may be configured to receive the matching AR data set from the database, and render, on a display, the image data of the book cover from the given book combined with the matching AR data set and a matching price.

### TECHNICAL FIELD

The present disclosure relates to the field of augmented reality, and, more particularly, to an augmented reality system for book covers and related methods.

### BACKGROUND

Augmented reality (AR) is an interactive experience of a real-world environment. In AR, objects in the real-world are “augmented” by computer-generated perceptual information. Typically, the computer-generated perceptual information is visual, but this information can span across multiple sensory modalities, including visual, auditory, haptic, somatosensory, and olfactory.

Although AR first was deployed in specialized hardware, AR has recently been deployed in the mobile phone platform. Typically, these mobile phone platform AR applications are limited to visual and auditory AR effects. Using the onboard image sensor and the display of the mobile phone platform, these mobile phone platform applications provide a versatile, albeit limited, AR experience. For example, in one application of AR on the mobile phone platform, the mobile device may be used to translate foreign text, see, e.g., Google Translate, as available from Alphabet Inc. of Mountain View, California. In yet another example, the mobile device may be used to provide navigational directions, see, e.g., Google Street View, as available from

Alphabet Inc. In some mobile phone platform applications, AR features have been used in online video games to enhance gameplay, such as Pokémon Go, as available from Niantic, Inc. of San Francisco, Calif.

In another application, AR has been used to enhance retail products. For example, in one approach, a wine label is enhanced with AR features, see, e.g., Augmented Reality Wine, as available from Treasury Wine Estates of Southbank, Melbourne, Australia.

### SUMMARY

Generally, an AR system may include at least one mobile wireless communications device comprising an image sensor, a display, and a processor coupled to the image sensor and the display. The processor may be configured to operate the image sensor to generate image data of a book cover from a given book. The AR system may comprise a server configured to store a database for a plurality of different books. The database may include a plurality of book cover images respectively for the plurality of different books, and a plurality of AR data sets respectively for the plurality of different books. The server may be configured to receive the image data of the book cover of the given book, and compare the image data with each of the plurality of book cover images to determine a matching book cover image and a matching AR data set from the database. The at least one mobile wireless communications device may be configured to receive the matching AR data set from the database, and render, on the display, the image data of the book cover from the given book combined with the matching AR data set and a matching price. Advantageously, the AR system may enhance the given book to a potential purchaser in an offline environment.

For example, each AR data set may include at least one of an animated book cover, a video data set, and an image data set. In some embodiments, the server may be configured to determine a matching book from the plurality of different books for the given book, search at least one online book merchant for the matching book, and determine the matching price for the matching book from the at least one online book merchant. The server may be configured to embed the matching price in the matching AR data set. The server may be configured to determine the matching price comprising a lowest price from among a plurality of online book merchants. The at least one mobile wireless communications device may be configured to render the image data with the matching price, the matching price comprising a link to an online entry of the matching book for the at least one online book merchant.

Additionally, the at least one mobile wireless communications device may be configured to generate the image data of the book cover from the given book by at least extracting rectangle-shaped objects from the image data of the book cover from the given book. The server may be configured to provide an administrative interface portal for modifying the database for the plurality of different books. For example, each AR data set of a subset of the plurality of AR data sets may comprise at least one uniform resource locator (URL), and the server may be configured to generate the subset of the plurality of AR data sets by at least downloading data from the at least one URL.

Another aspect is directed to an AR server in communication with at least one mobile wireless communications device generating image data of a book cover from a given book. The server may include a processor and memory cooperating therewith and configured to store a database for a plurality of different books. The database may comprise a plurality of book cover images respectively for the plurality of different books, and a plurality of AR data sets respectively for the plurality of different books. The processor may be configured to receive the image data of the book cover of the given book, compare the image data with each of the plurality of book cover images to determine a matching book cover image and a matching AR data set from the database, and send the matching AR data set from the database to the at least one mobile wireless communications device for rendering of the image data of the book cover from the given book combined with the matching AR data set and a matching price.

Yet another aspect is directed to a method of providing an AR experience in a system comprising at least one mobile wireless communications device generating image data of a book cover from a given book, and a server in communication with the at least one mobile wireless communications device. The method may include storing a database, at the server, for a plurality of different books. The database may include a plurality of book cover images respectively for the plurality of different books, and a plurality of AR data sets respectively for the plurality of different books. The method may also include receiving, at the server, the image data of the book cover of the given book. The method may include comparing, at the server, the image data with each of the plurality of book cover images to determine a matching book cover image and a matching AR data set from the database, and sending, from the server, the matching AR data set from the database to the at least one mobile wireless communications device for rendering of the image data of the book cover from the given book combined with the matching AR data set and a matching price.

### BRIEF DESCRIPTION OF THE DRAWINGS

FIG. 1 is a schematic diagram of an AR system, according to the present disclosure.

FIGS. 2A-2E are images of an AR version of the given book in an example embodiment of the AR system, according to the present disclosure.

FIGS. 3 and 4 are flowcharts illustrating a method for providing an AR experience in the system, according to the present disclosure.

FIG. 5 is a flowchart illustrating a logic for an administrative interface portal in the AR system, according to the present disclosure.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

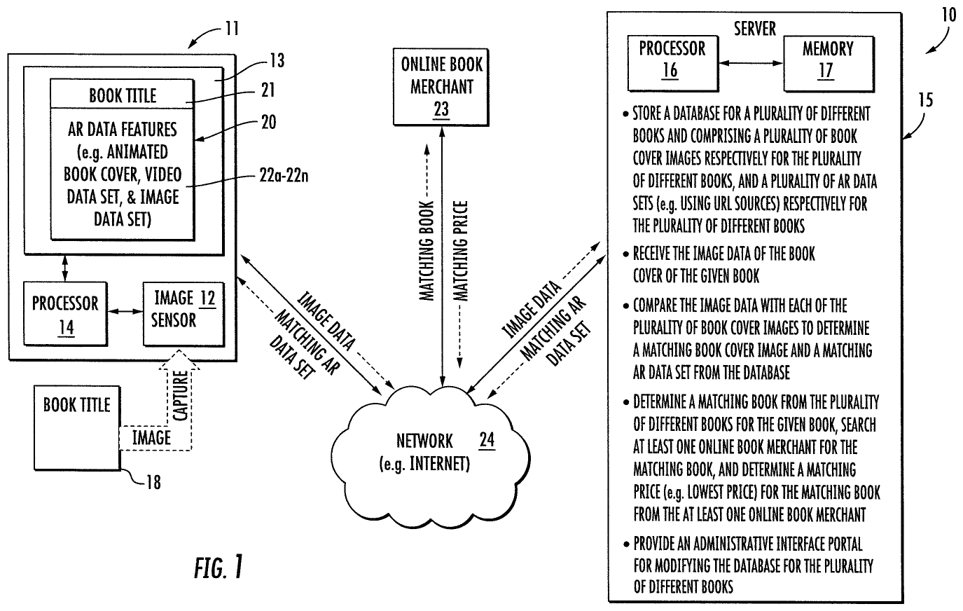

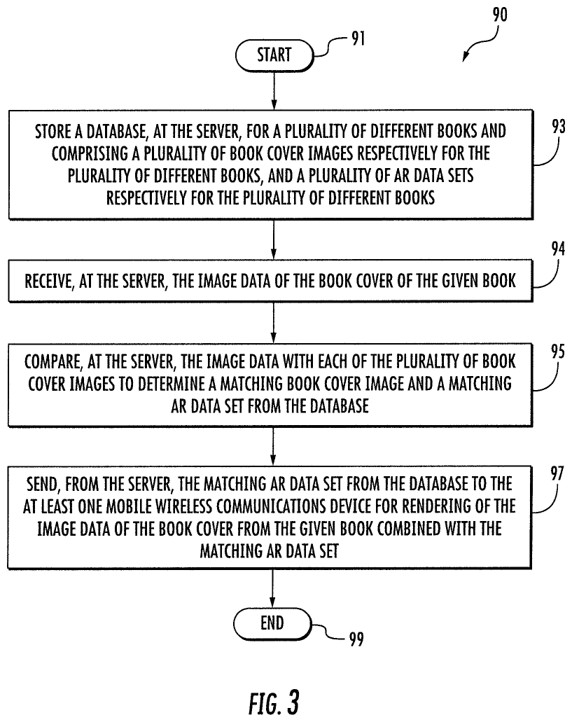

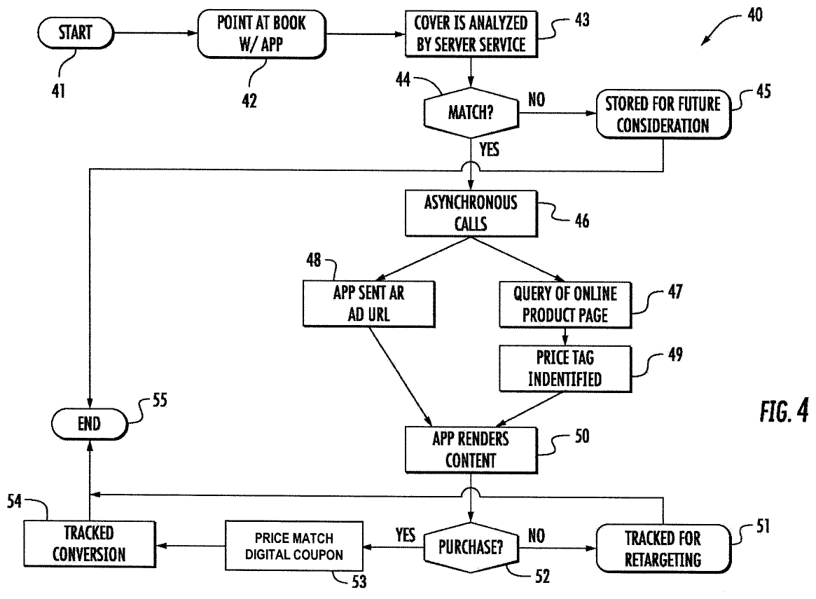

Referring initially to FIGS. 1 and 3, an AR system 10 according to the present disclosure is now described. Also, with reference to a flowchart 90, a method for providing an AR experience in the AR system 10 is described. (Block 91). The AR system 10 illustratively includes a mobile wireless communications device 11. Of course, for illustrative clarity, only one mobile wireless communications device 11 is shown, but the AR system 10 may comprise a plurality of mobile wireless communications devices with respective users.

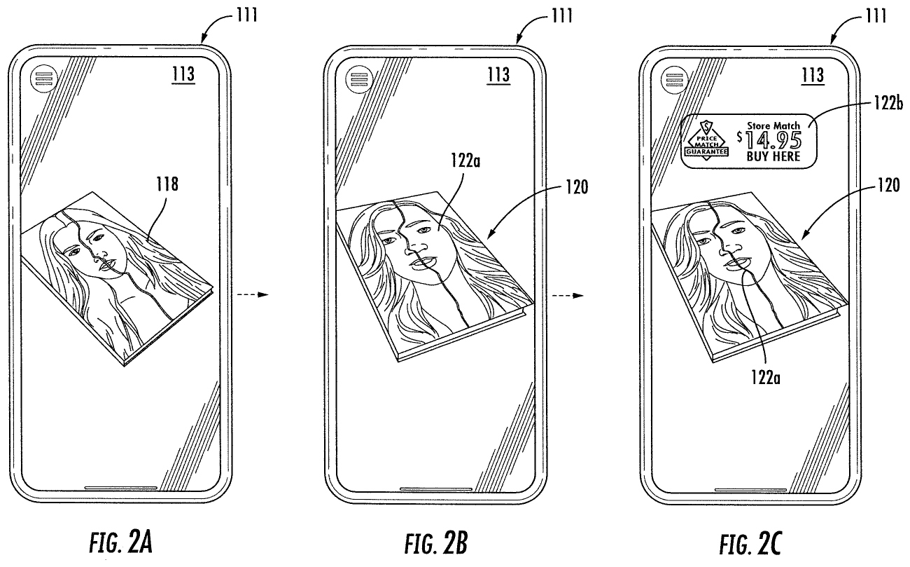

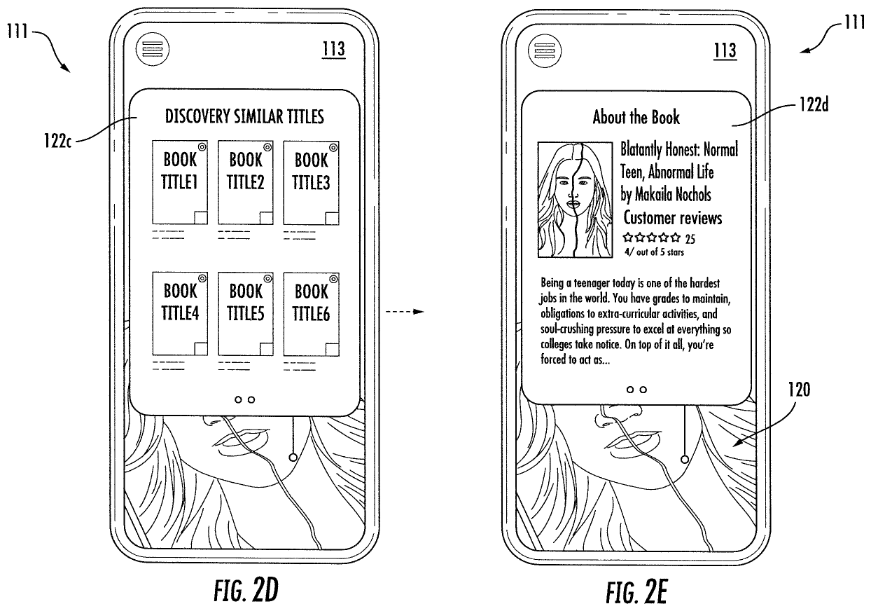

The mobile wireless communications device 11 illustratively includes an image sensor 12, a display 13, and a processor 14 coupled to the image sensor and the display. The display 13 may comprise a touchscreen display in some embodiments (FIGS. 2A-2E). The image sensor 12 may comprise an integrated circuit (IC) image sensor (e.g. charge-coupled devices (CCD), active pixel sensors in complementary metal-oxide-semiconductor (CMOS) or N-type metal-oxide-semiconductor (NMOS, Live MOS) technologies), which is sensitive to at least the visible radiation frequency range, and could comprise additionally or alternatively other operational frequency ranges, such as infrared.

As will be appreciated, the teachings disclosed herein may be implemented via a software application native to the mobile operating system (OS) of the mobile wireless communications device 11 (e.g. iOS, or Android). In other embodiments, the mobile wireless communications device 11 may be configured via firmware or other low level OS elements. In yet other embodiments, the teachings herein may be implemented on the mobile wireless communications device 11 via a web based application (e.g. an HTML5 application).

The processor 14 is configured to operate the image sensor 12 to generate image data of a book cover (i.e. one or both of the front book cover and the back book cover) from a given book 18.

In the illustrated embodiment, the AR system 10 implements an AR experience for the given book 18. Of course, as will be appreciated by those skilled in the art, these teachings can be readily extended to other products/items with largely planar packaging. For example, these other products may include other publication materials (e.g. magazines, newspapers, posters, paintings, pictures), and items packaged in planar boxes. Of course, with some modification for optical distortion, these teachings can also be extended to other products/items with non-planar packaging

As will be appreciated, the mobile wireless communications device 11 is configured to execute an AR software application that operates the image sensor 12 and the associated live video feed generated therefrom. For example, the image data (i.e. the data generated by the live video feed) may comprise an image representation of the book cover in a file format, such as the Joint Photographic Experts Group (JPEG) file format or the Portable Network Graphics (PNG) file format. Of course, these file formats are merely exemplary, and other file formats could be used.

In some embodiments, the mobile wireless communications device 11 is configured to generate the image data of the book cover from the given book 18 by at least extracting rectangle-shaped objects from the image data of the book cover from the given book. As will be appreciated by those skilled in the art, the mobile wireless communications device 11 is configured to execute a shape-detection algorithm to locate rectangle-shaped objects in a view of the image sensor 12.

The AR system 10 illustratively includes a server 15 in communication with the mobile wireless communications device 11 over a network 24 (e.g. the Internet) and comprising a processor 16 and memory 17 cooperating therewith. The server 15 is configured to store a database for a plurality of different books. The database comprises a plurality of book cover images respectively associated with the plurality of different books, and a plurality of AR data sets respectively associated with the plurality of different books. (Block 93). For example, each AR data set may include at least one of an animated book cover (See, e.g., FIGS. 2A-2E), a video data set, and an image data set. The AR data set may comprise a commercial advertisement for another book related to the given book 18, three-dimension animations, price labels from one or more book merchants, community ratings for the given book, and messages from one or more of critics and authors of the given book. In other words, the given book 18 is not only enhanced to encourage purchase by the user, but other offers for sale are presented to the user, i.e. upselling the user in the AR experience.

In some embodiments, the plurality of AR data sets is stored locally at the server 15. In other embodiments, each AR data set of a subset of the plurality of AR data sets may comprise at least one URL, and the server 15 is configured to generate the subset of the plurality of AR data sets by at least downloading data from the at least one URL.

Alternatively, the at least one URL may be sent to the mobile wireless communications device 11, which can download the needed content directly without the intermediary of the server.

In other embodiments, the mobile wireless communications device 11 is configured to perform optical character recognition (OCR) on the image data to generate a unique identifier for the given book 18. For example, the unique identifier may comprise a title of the given book 18, or the International Standard Book Number (ISBN) value of the given book. In yet other embodiments, the raw image data is passed to the server 15, where the OCR processing is performed.

In particular, for each of the plurality of different books, the database includes an AR book database entry. The AR book database entry may comprise one or more of a book title, a clean image of a respective book front/back cover (i.e. an book cover signature image), an ISBN value, one or more URL links to corresponding item pages on a plurality of online book merchants (i.e. the pages where the respective book can be purchased), and one or more links to image data and video data.

The server 15 is configured to receive the image data of the book cover of the given book 18, and perform the aforementioned processing to determine a book cover signature of the given book 18. The server 15 is configured to compare the image data with each of the plurality of book cover images to determine a matching book cover image and a matching AR data set from the database. (Blocks 94-95). In other words, the server 15 is matching the book cover of the given book 18 with a corresponding AR book database entry from the database.

Once the matching AR book database entry from the database is determined, the matching AR data set is transmitted to the mobile wireless communications device 11. The mobile wireless communications device 11 is configured to receive the matching AR data set from the database, and render, on the display 13, the image data of the book cover from the given book 18 combined with the matching AR data set. (Blocks 97, 99).

In other words, the mobile wireless communications device 11 is configured to render an AR version 20 of the given book 18. The AR version 20 of the given book 18 illustratively includes at least a portion 21 of the book cover, and a plurality of AR features 22a-22n overlaid on top of the book cover, i.e. the AR version of the given book comprises a composite of real world features and the plurality of AR features 22a-22n. In some embodiments, the original book cover is completely covered by the plurality of AR features 22a-22n. In other embodiments, one or more of the plurality of AR features 22a-22n are rendered in callouts (See FIGS. 2A-2C). The generating of the image data and the rendering of the AR version 20 of the given book 18 is performed in real-time, or near simultaneously.

In the illustrated embodiment, the server 15 is configured to determine a matching book from the plurality of different books for the given book 18, and search one or more online book merchants 23 for the matching book. As will be appreciated, although the illustrated embodiment includes a single online book merchant 23 for illustrative clarity, the server 15 may search a plurality of online book merchants (e.g. Amazon, Walmart). The server 15 is configured determine a matching price for the matching book from the one or more online book merchants. As will be appreciated, in some embodiments, the matching price comprises a lowest price from among the one or more online book merchants and/or offline book merchants, thereby providing a price checking feature. In other embodiments, the matching price comprises a regular price at the offline book merchant (i.e. the actual current price of the given book 18 when located at the vendor: price lookup), or a discounted price. Indeed, the discounted price may be presented only in some circumstances, such as when online book vendors sell the given book 18 at a lower price.

Also, the server 15 may be configured to embed the matching price in the matching AR data set (See FIGS. 2A-2C). The mobile wireless communications device 11 is configured to render the AR version 20 of the given book 18 to include an active link for providing indicia/proof of the matching price for offline purchase. For example, if the user is at a brick and mortar book merchant, i.e. an offline book merchant, and the matching price is lower than that of the offline book merchant, the user can access the indicia to enable the offline book merchant to price match the matching price. Advantageously, this prevents the offline book merchant from losing a purchase to the online book merchant, and the user may receive the lowest price for the given book 18.

The server 15 is configured to provide an administrative interface portal for modifying the database for the plurality of different books. For example, the administrative interface portal would enable an administrator to easily add and remove books from the database or make changes to existing AR book database entries in the database. The administrative interface portal may comprise one or more templates for creating AR data sets.

In one embodiment, the matching AR data set may be selectively altered based upon a geolocation value from the mobile wireless communications device 11. The mobile wireless communications device 11 may comprise a location device (e.g. a global positioning system (GPS) device) configured to generate the geolocation value. In particular, if the mobile wireless communications device 11 is located at a location of a merchant with a price matching policy, the AR data set may include a URL link to the price matching policy. For example, the community rating for the matching AR data set may be limited to an area comprising a set radius around the geolocation value. Also, in the embodiments where the matching price comprises a price associated with the offline book vendor, the geolocation value is used to determine an identity of the offline book vendor.

Moreover, in other embodiments, the AR data set may comprise a commercial advertisement related to a subject matter of the given book 18. For example, if the given book 18 comprises fantasy based subject matter, the AR version 20 of the given book 18 may include a video or animation related to the fantasy based subject matter. Indeed, for publishers/content providers having a common subject matter published across multiple types of media, such as books, theatrical movies, television shows, theme parks, live shows, etc., the AR version 20 of the given book 18 may include the cross-platform content. For example, the given book 18 may comprise a book adaptation of a movie, and the AR version 20 of the given book may comprise at least a portion of the movie.

In other words, the AR version 20 of the given book 18 may be used to upsell the user on cross-platform content. Indeed, using a time value, the geolocation value, and a known schedule of live events, the AR version 20 of the given book 18 may include advertisements for live events near the user.

Yet another aspect is directed to a method of providing an AR experience in the AR system 10 comprising at least one mobile wireless communications device 11 generating image data of a book cover from a given book 18, and a server 15 in communication with the at least one mobile wireless communications device. The method includes storing a database, at the server 15, for a plurality of different books. The database comprises a plurality of book cover images respectively for the plurality of different books, and a plurality of AR data sets respectively for the plurality of different books. The method includes receiving, at the server, the image data of the book cover of the given book 18. The method includes comparing, at the server 15, the image data with each of the plurality of book cover images to determine a matching book cover image and a matching AR data set from the database, and sending, from the server, the matching AR data set from the database to the at least one mobile wireless communications device 11 for rendering of the image data of the book cover from the given book 18 combined with the matching AR data set.

Referring now additionally to FIGS. 2A-2C, another embodiment of the mobile wireless communications device 111 in the AR system 10 is now described. In this embodiment of the mobile wireless communications device 111, those elements already discussed above with respect to FIGS. 1-3 are incremented by 100 and most require no further discussion herein. This embodiment differs from the previous embodiment in that this mobile wireless communications device 111 illustratively includes a touch screen display 113. Also, in this embodiment, the mobile wireless communications device 111 is configured to render the AR version 120 of the given book 118 as a live/living book cover 122a. Also, the mobile wireless communications device 111 is configured to render the AR version 120 with a callout 122b including the matching price. Here, the matching price comprises a link to an online entry of the matching book for the online book merchant.

In FIG. 2D, the mobile wireless communications device 111 is configured to render the AR version 120 to illustratively include another callout 122c comprising a plurality of suggested other books. The plurality of suggested other books may comprise books related to a publisher of the given book 118, and/or books related to a subject matter of the given book. In FIG. 2E, the mobile wireless communications device 111 is configured to render the AR version 120 to illustratively include another callout 122d comprising a community rating and at least one review of the given book 118.

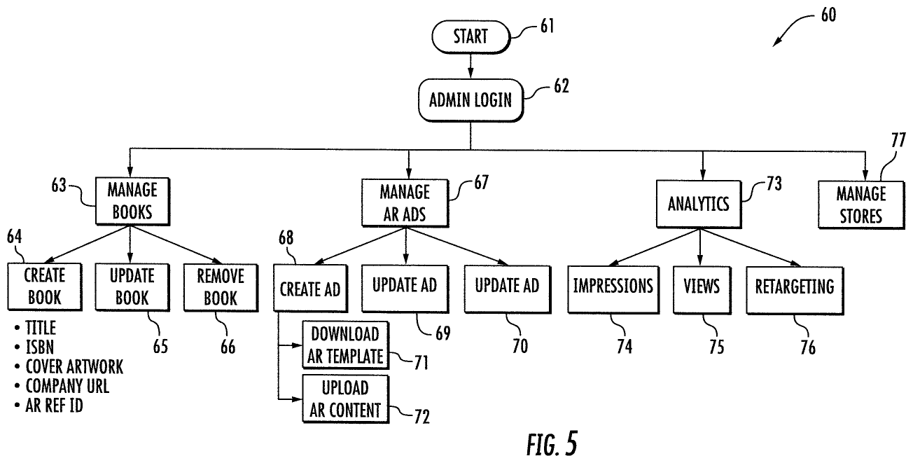

Referring now to FIG. 4, another embodiment of the method for providing an AR experience in the AR system 10 is now described with reference to a flowchart 40. This method illustratively includes an acquisition of the image data from the given book 18. (Blocks 41-42). The method illustratively includes an analysis of the image data from the book cover of the given book 18 (Block 43). The method illustratively includes comparing the image data with each of the plurality of book cover images to determine a matching book cover image and a matching AR data set from the database. (Block 44). If there is no match, the image data is stored for future consideration or advertising. (Blocks 44-45). In other words, the system operator may generate a listing of non-enrolled books and send solicitation communications to invite book publishers to enroll in the database.

The method illustratively includes, via the server 15, sending the mobile wireless communications device 11 URLs for accessing the matching AR data set from the database, and via the server 15, querying the online product page of the one or more online book merchants 23. (Blocks 46-48). The querying step includes identifying or parsing the price tag within the online product page. (Block 49). Once the mobile wireless communications device 11 has downloaded the matching AR data set, the mobile wireless communications device renders, on the display 13, the image data of the book cover from the given book 18 combined with the matching AR data set. (Block 50). If the user of the mobile wireless communications device 11 makes an offline purchase, the mobile wireless communications device may provide evidence for price match at the offline book vendor, for example, a screenshot of the matching price from the online book merchant. (Blocks 52-53). The method illustratively includes tracking the offline conversion, and if no purchase is made, the query is stored for future retargeting (e.g. targeting advertising). (Blocks 54-55, 51). In other words, the mobile wireless communications device 11 may prompt the user later on to purchase the given book 18.

Referring now to FIG. 4, another embodiment of the method for providing an AR experience in the AR system 10 is now described. In particular, the flowchart 60 shows a logic of the administrative interface portal provided by the server 15. (Blocks 61-62). The administrative interface portal illustratively includes a books management module, which permits the administrator to change one or more of the books in the plurality of different books in the database. (Blocks 63-66). The administrative interface portal illustratively includes an AR advertisements management module, which permits the administrator to change one or more of the AR data sets in the plurality of AR data sets in the database. (Blocks 67-72). The administrative interface portal illustratively includes an analytics management module, which permits the administrator to view the performance of the AR data sets in the database. (Blocks 73-76). The administrative interface portal illustratively includes a store management module, which permits the administrator to change one or more of the online book vendors the server 15 will query for the matching price. (Block 77).

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. An augmented reality (AR) system comprising:
at least one mobile wireless communications device comprising an image sensor, a display, and a processor coupled to said image sensor and said display, said processor configured to operate said image sensor to generate image data of a book cover from a given book; and
a server configured to
store a database for a plurality of different books and comprising a plurality of book cover images respectively for the plurality of different books, and a plurality of AR data sets respectively for the plurality of different books,
receive the image data of the book cover of the given book, and
compare the image data with each of the plurality of book cover images to determine a matching book cover image and a matching AR data set from the database;
said at least one mobile wireless communications device configured to
receive the matching AR data set from the database, and
render, on said display, the image data of the book cover from the given book combined with the matching AR data set and a matching price.

2. The AR system of claim 1 wherein each AR data set comprises at least one of an animated book cover, a video data set, and an image data set.

3. The AR system of claim 1 wherein said server is configured to determine a matching book from the plurality of different books for the given book, search at least one online book merchant for the matching book, and determine the matching price for the matching book from the at least one online book merchant.

4. The AR system of claim 3 wherein said server is configured to embed the matching price in the matching AR data set.

5. The AR system of claim 3 wherein said server is configured to determine the matching price comprising a lowest price from among a plurality of online book merchants.

6. The AR system of claim 3 wherein said at least one mobile wireless communications device is configured to render the image data with the matching price, the matching price comprising a link to an online entry of the matching book for the at least one online book merchant.

7. The AR system of claim 1 wherein said at least one mobile wireless communications device is configured to generate the image data of the book cover from the given book by at least extracting rectangle-shaped objects from the image data of the book cover from the given book.

8. The AR system of claim 1 wherein said server is configured to provide an administrative interface portal for modifying the database for the plurality of different books.

9. The AR system of claim 1 wherein each AR data set of a subset of the plurality of AR data sets comprises at least one uniform resource locator (URL); and wherein said server is configured to generate the subset of the plurality of AR data sets by at least downloading data from the at least one URL.

10. An augmented reality (AR) server in communication with at least one mobile wireless communications device generating image data of a book cover from a given book, the server comprising:
a processor and memory cooperating therewith and configured to
store a database for a plurality of different books and
comprising a plurality of book cover images respectively for the plurality of different books, and a plurality of AR data sets respectively for the plurality of different books,
receive the image data of the book cover of the given book,
compare the image data with each of the plurality of book cover images to determine a matching book cover image and a matching AR data set from the database, and
send the matching AR data set from the database to the at least one mobile wireless communications device for rendering of the image data of the book cover from the given book combined with the matching AR data set and a matching price.

11. The AR server of claim 10 wherein each AR data set comprises at least one of an animated book cover, a video data set, and an image data set.

12. The AR server of claim 10 wherein said processor is configured to determine a matching book from the plurality of different books for the given book, search at least one online book merchant for the matching book, and determine the matching price for the matching book from the at least one online book merchant.

13. The AR server of claim 12 wherein said processor is configured to embed the matching price in the matching AR data set.

14. The AR server of claim 12 wherein said processor is configured to determine the matching price comprising a lowest price from among a plurality of online book merchants.

15. The AR server of claim 12 wherein the at least one mobile wireless communications device renders the image data with the matching price, the matching price comprising a link to an online entry of the matching book for the at least one online book merchant.

16. The AR server of claim 10 wherein the at least one mobile wireless communications device generates the image data of the book cover from the given book by at least extracting rectangle-shaped objects from the image data of the book cover from the given book.

17. The AR server of claim 10 wherein said processor is configured to provide an administrative interface portal for modifying the database for the plurality of different books.

18. A method of providing an augmented reality (AR) experience in a system comprising at least one mobile wireless communications device generating image data of a book cover from a given book, and a server in communication with the at least one mobile wireless communications device, the method comprising:
storing a database, at the server, for a plurality of different books and comprising a plurality of book cover images respectively for the plurality of different books, and a plurality of AR data sets respectively for the plurality of different books;
receiving, at the server, the image data of the book cover of the given book;
comparing, at the server, the image data with each of the plurality of book cover images to determine a matching book cover image and a matching AR data set from the database; and
sending, from the server, the matching AR data set from the database to the at least one mobile wireless communications device for rendering of the image data of the book cover from the given book combined with the matching AR data set and a matching price.

19. The method of claim 18 wherein each AR data set comprises at least one of an animated book cover, a video data set, and an image data set.

20. The method of claim 18 further comprising determining, at the server, a matching book from the plurality of different books for the given book, searching, at the server, at least one online book merchant for the matching book, and determining, at the server, the matching price for the matching book from the at least one online book merchant.
